(19) United States
(12) Patent Application Publication
(10) Pub. No.: US 2011/0153203 A1
(43) Pub. Date: Jun. 23, 2011

(54) METHOD AND TERMINAL FOR SEARCHING INTEREST POINTS

(76) Inventor: Weihong Lu, Shenzhen (CN)

(21) Appl. No.: 12/970,589

(22) Filed: Dec. 16, 2010

(30) Foreign Application Priority Data
Dec. 17, 2009 (CN) 200910252506.0

(51) Int. Cl. G01C 21/26; G01C 21/00

(52) U.S. Cl. 701/202

(57) ABSTRACT

A method and a terminal for searching for interest points in the field of location services are provided to solve the problem in the prior art that the interest points cannot be determined according to multiple locations. The method includes: obtaining a set of candidate interest points; and finding a target interest point from the set of candidate interest points, in which location relationships between the target interest point and each of at least two known locations meet a preset rule 1. The method may also include the following blocks: finding a target location point, in which location relationships between the target location point and each of at least two known locations meet a preset rule; and searching for a target interest point within a preset distance to the target location point. The provided method and terminal are mainly applied to the field of location services.

### CROSS-REFERENCE TO RELATED APPLICATION

This application claims priority to Chinese Patent Application No. 200910252506.0, filed on Dec. 17, 2009, which is hereby incorporated by reference in its entirety.

### FIELD OF THE TECHNOLOGY

The present invention relates to the field of location services, and more particularly to a method and a terminal for searching for interest points.

### BACKGROUND OF THE INVENTION

Mobile location services are services provided for users and related to locations of the users with support of an electronic map platform. The services may also be called location-based services or location services. Interest-point services provide information related to user locations. For example, when a driver is traveling in an unfamiliar area and needs to find a gas station nearby, the desired information is displayed on his/her mobile phone, with the nearest location available marked out. Some services also provide addresses, telephone numbers, E-mail addresses, location descriptions (such as gas stations, bicycle retail stores, and restaurants), and route planning and navigation that lead to the selected location.

In the prior art, according to the technology of the mobile location services, locations of interest points are searched for based on only one location, for example, searching for hotels within 2 kilometers of a location. With increasingly closer interpersonal interactions, it is in urgent need of determining interest points based on multiple locations. For example, several persons at different locations intend to find a place that is almost equally close to each person. Or, a person on a business trip needs to go to several places, and he/she intends to find a hotel that is not too far away from each of the places. However, interest points cannot be determined by searching based on multiple locations in the prior art.

### SUMMARY OF THE INVENTION

The embodiments of the present invention provide a method and a terminal for searching for interest points, so that the searching for interest points can be implemented according to multiple different locations.

To achieve the preceding objective, the present invention provides the following technical solutions:

A method for searching for interest points includes:

A set of candidate interest points is obtained.

A target interest point is found from the set of candidate interest points, in which location relationships between the target interest point and each of at least two known locations meet a preset rule 1.

A terminal for searching for interest points includes an obtaining unit and a finding unit.

The obtaining unit is configured to obtain a set of candidate interest points.

The finding unit is configured to find a target interest point from the set of candidate interest points, in which location relationships between the target interest point and each of at least two known locations meet a preset rule 1.

The method for searching for interest points may also be implemented in a second manner. The method includes:

A target location point is found, in which location relationships between the target location point and each of at least two known locations meet a preset rule.

A target interest point is searched for within a preset distance to the target location point.

To implement the second method for searching for interest points, a second terminal for searching for interest points is provided according to the technical solutions. The second terminal includes a finding unit and a search unit.

The finding unit is configured to find a target location point, in which location relationships between the target location point and each of at least two known locations meet a preset rule.

The search unit is configured to search for a target interest point within a preset distance to the target location point.

Two methods and two terminals for searching for interest points are provided in the present invention. In one method, a set of candidate interest points is obtained, which includes a target interest point required by a user. Then, the target interest point is found from the set of candidate interest points according to a preset rule, in which location relationships between the target interest point and each of at least two known locations meet a preset rule 1, that is, the target interest point is determined by the at least two known locations. In the other method, a target location point is found, in which location relationships between the target location point and each of at least two known locations meet a preset rule. The target location is determined by the at least two known locations, and acts as a reference location for determining a target interest point with the at least two known locations. Then, the target interest point is searched for within a preset distance to the target location point. The target interest point obtained by using the preceding two methods is determined according to at least two known locations and the same preset rule, so that the determination of interest points by searching according to multiple locations is achieved.

### BRIEF DESCRIPTION OF THE DRAWINGS

To illustrate the technical solutions according to the embodiments of the present invention or in the prior art more clearly, the accompanying drawings for describing the embodiments or the prior art are introduced briefly in the following. Apparently, the accompanying drawings in the following description are only some embodiments of the present invention, and persons of ordinary skill in the art can derive other drawings from the accompanying drawings without creative efforts.

FIG. 1 is a flow chart of a first method for searching for interest points according to an embodiment of the present invention;

FIG. 2 is a block diagram of a first terminal for searching for interest points according to an embodiment of the present invention;

FIG. 3 is a flow chart of a second method for searching for interest points according to an embodiment of the present invention;

FIG. 4 is a block diagram of a second terminal for searching for interest points according to an embodiment of the present invention;

FIG. 5 is a flow chart of a method for searching for interest points according to a first embodiment of the present invention;

FIG. 6 is a block diagram of a terminal for searching for interest points according to the first embodiment of the present invention;

FIG. 7 is a flow chart of a method for searching for interest points according to a second embodiment of the present invention; and

FIG. 8 is a block diagram of a terminal for searching for interest points according to the second embodiment of the present invention.

### DETAILED DESCRIPTION OF THE EMBODIMENTS

To solve the problem in the prior art that the interest points can be searched for based on only one location, a method and a terminal for searching for interest points are provided in the embodiments of the present invention, so that a target interest point can be searched for according to multiple different known locations, and the target interest point meets requirements of each known location.

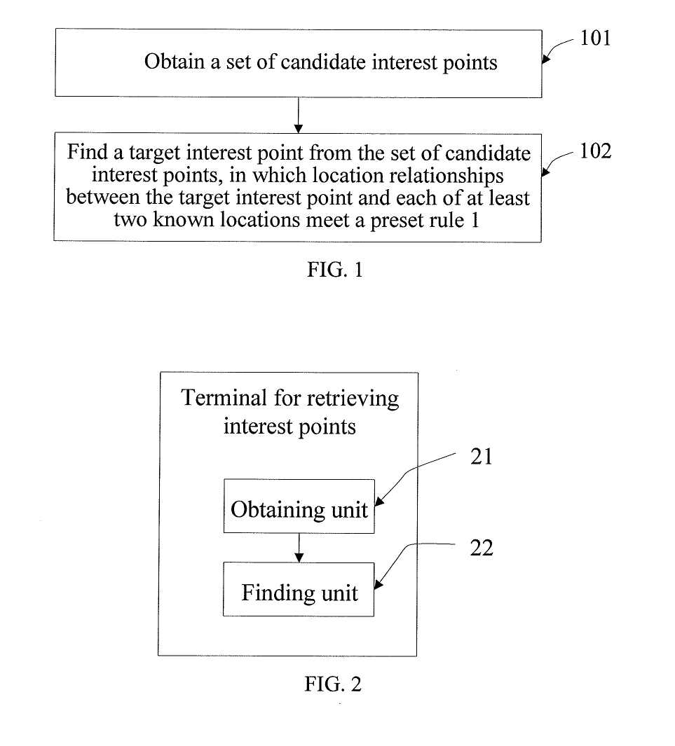

In an embodiment, the present invention provides a method for searching for interest points. As shown in FIG. 1, the method includes:

In block 101, obtain a set of candidate interest points. The set of candidate interest points includes multiple candidate interest points that meet different requirements of multiple known locations.

In block 102, find a target interest point from the set of candidate interest points, in which location relationships between the target interest point and each of at least two known locations meet a preset rule 1.

To implement the preceding method, in an embodiment, the present invention further provides a terminal for searching for interest points. As shown in FIG. 2, the terminal includes an obtaining unit 21 and a finding unit 22.

The obtaining unit 21 is configured to obtain a set of candidate interest points. The set of candidate interest points provides a reference for determining a target interest point. Interest points that do not meet requirements of known locations are filtered out from the set of candidate interest points, and a target interest point is included in the set of candidate interest points. Therefore, the search range for the target interest point is narrowed down, and the target interest point can be easily found.

Then, the finding unit 22 is configured to find the target interest point from the set of candidate interest points, in which location relationships between the target interest point and each of at least two known locations meet a preset rule 1. The target interest point found by the finding unit 22 meets the requirements of each of the known locations, and thus the determination of the interest points according to different locations is also achieved.

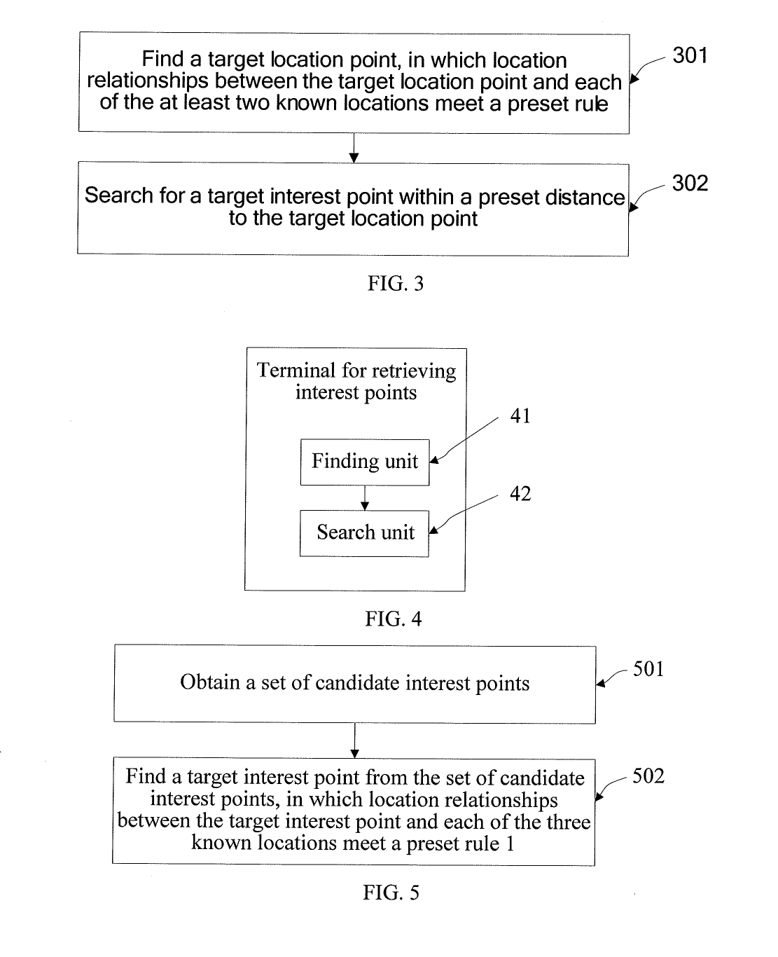

The method for searching for interest points provided in the preceding embodiment of the present invention may also be implemented in a second manner. As shown in FIG. 3, the method includes the following blocks:

In block 301, find a target location point according to at least two known locations, in which location relationships between the target location point and each of the at least two known locations meet a preset rule. The target location point is a reference location for searching for a target interest point. The preset rule is the same as the preset rule described in block 102.

In block 302, search for the target interest point within a preset distance to the target location point. Because the target location point meets the requirements of each of the known locations, for example, a requirement of a distance between each of the known locations and the target interest point, or a requirement of time required from each of the known locations to the target interest point, the target interest point obtained by searching within the preset distance to the target location point also meets the requirements of each of the known locations.

To implement the second method for searching for interest points, in an embodiment, the present invention also provides a second terminal for searching for interest points. As shown in FIG. 4, the terminal includes a finding unit 41 and a search unit 42.

The finding unit 41 is configured to find a target location point, in which location relationships between the target location point and each of at least two known locations meet a preset rule. Then, the search unit 42 is configured to search for a target interest point within a preset distance to the target location point. The terminal achieves the objective of determining the target interest point according to the at least two known locations.

In the preceding two methods, to achieve the objective of the present invention, a target interest point is finally determined through the same preset rule. During the implementation of the first method, a set of candidate interest points is determined first. Then, a target interest point is found from the set of candidate interest points according to the preset rule, in which location relationships between the target interest point and each of at least two known locations meet a preset rule 1. During the implementation of the second method, a target location point acting as a reference is determined according to the preset rule first. Then, a target interest point is searched for around the target location point. In both methods, the target interest point is determined according to the at least two known locations and the same preset rule, so that the problem in the prior art that interest points cannot be determined according to multiple locations is solved.

The technical solutions of the present invention are clearly described in the following with reference to the accompanying drawings. It is obvious that the embodiments to be described are only a part rather than all of the embodiments of the present invention. All other embodiments obtained by persons skilled in the art based on the embodiments of the present invention without creative efforts shall fall within the protection scope of the present invention.

First Embodiment

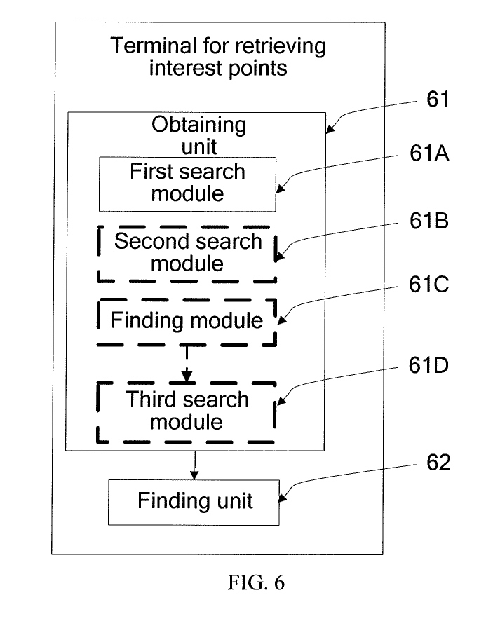

According to the embodiment of the present invention, in an assumed application scenario of three different known locations, a hotel needs to be determined so that distances from the three different known locations to the hotel are close, or it takes approximately the same time for persons from the three different known locations to the hotel. In this case, the target interest point is the hotel. Referring to FIG. 5, an implementing process of the first method for searching for interest points is described in detail below. The method includes the following blocks:

In block 501, obtain a set of candidate interest points. The set of candidate interest points includes multiple candidate hotels that meet requirements of the three known locations. This block may be implemented in one of the following manners:

In a first manner, a set of candidate interest points is formed by candidate interest points found within a preset distance to each of the known locations. Corresponding hotels can be found around one known location, and a set of candidate hotels is formed by candidate hotels corresponding to each of the known locations, so that hotels that do not meet the requirements of the known locations are filtered out.

In a second manner, a set of candidate interest points is formed by candidate interest points found in a designated area, in an area exclusive of a designated area, on a designated path, or in an area exclusive of a designated path. When a user demands that a target hotel is located in a designated area, in an area exclusive of a designated area, on a designated path, or in an area exclusive of a designated path (for example, a path where a traffic jam often occurs), candidate hotels are first searched for in the designated area, in the area exclusive of the designated area, on the designated path, or in the area exclusive of the designated path, then hotels that do no meet the requirements of the user are deleted, such as those out of the designated area, thereby narrowing down the search range for the target hotel.

In a third manner, a target location point is first found based on the three known locations according to a preset rule 1. Location relationships between the target interest point and the three known locations meet a preset rule 2. The preset rule 2 is different from the preset rule 1. Then, a set of candidate interest points is formed by candidate interest points found within a preset distance to the target location point.

In block 502, find a target interest point from the set of candidate interest points, in which location relationships between the target interest point and the three known locations meet a preset rule 1. The preset rule 1 and the preset rule 2 are different rules selected from the following.

In Rule A, a difference between any two linear distances is within a preset range, where the two linear distances are among linear distances between the target hotel and each of the at least two known locations.

Linear distances between each candidate hotel in the set of candidate hotels and the three known locations are calculated, and if a difference between the linear distances is within a preset range, the corresponding candidate hotel is determined as the target hotel. If the preset range is narrow, the linear distances between each of the known locations and the target hotel are close or equal.

In Rule B, a difference between any two actual distances is within a preset range, where the two actual distances are among actual distances between the target hotel and each of the at least two known locations.

Actual distances between each candidate hotel in the set of candidate hotels and the three known locations are calculated, and if a difference between the actual distances is within a preset range, the corresponding candidate hotel is determined as the target hotel. If the preset range is narrow, the actual distances between each of the known locations and the target hotel are close or equal.

In Rule C, a difference between any navigation time is within a preset range, where the navigation time is among navigation time between the target hotel and each of the at least two known locations.

The time required from each candidate hotel in the set of candidate hotels to each of the three known locations is calculated, and if a difference between the time is within a preset range, the corresponding candidate hotel is determined as the target hotel. If the preset range is narrow, the time required from each of the known locations to the target hotel by different means of travel is close or equal. The means of travel may be on foot, by car, or by public transport. If the user walks to the hotel, a reference time can be calculated according to the actual distance and the normal speed of a person on foot. The reference time provides a time roughly required by the user. If the user travels by public transport, for example, by subway, a reference time roughly required by the user may be provided according to the schedule of the subway. If the user drives to the hotel, a reference time can be calculated according to the speed of the car and the actual distance.

In Rule D, a sum of linear distances between the target hotel and each of at least two known locations is the smallest. A sum of linear distances between each candidate hotel in the set of candidate hotels and each of the three known locations is calculated, and the candidate hotel corresponding to the smallest sum is determined as the target hotel.

In Rule E, a sum of actual distances between the target hotel and each of at least two known locations is the smallest. A sum of actual distances between each candidate hotel in the set of candidate hotels and each of the three known locations is calculated, and the candidate hotel corresponding to the smallest sum of the actual distances is determined as the target hotel.

In Rule F, a sum of navigation time between the target hotel and each of at least two known locations is the smallest. A sum of time required from each candidate hotel in the set of candidate hotels to each of the three known locations is calculated, and the candidate hotel corresponding to the smallest sum of the time is determined as the target hotel.

If the set of candidate interest points is formed in the third manner in block 501, the target location point is found by using the preset rule 1, and the preset rule 1 is different from the preset rule 2 used in this block. For example, when a target location point is searched for, the rule in which the navigation time between the target hotel and each of the three known locations is close is used, and then, a set of candidate interest points is formed by searching according to the found target location point. Further, the rule in which the actual distances between the target hotel and each of the three known locations are close is used to select the final target hotel.

The target hotel is determined by the preset rules and the known locations, and thus meets the requirements of each of the known locations at the same time. Therefore, the determination of the interest points according to multiple different locations is achieved.

In an embodiment, the present invention further provides a terminal for searching for interest points. Referring to FIG. 6, the terminal includes an obtaining unit 61 and a finding unit 62.

The obtaining unit 61 includes a first search module 61A configured to search for candidate interest points within a preset distance to each known location and form a set of candidate interest points with the found candidate interest points.

Alternatively, the obtaining unit 61 may also include a second search module 61B, configured to search for candidate interest points in a designated area, in an area exclusive of a designated area, on a designated path, or in an area exclusive of a designated path, then form a set of candidate interest points with the found candidate interest points.

Alternatively, the obtaining unit 61 may also include a finding module 61C and a third search module 61D.

The finding module 61C is configured to find a target location point, in which location relationships between the target location point and each of at least two known locations meet a preset rule 2, and the preset rule 2 is different from the preset rule 1.

The third search module 61D is configured to search for candidate interest points within a preset distance to the target location point found by the finding module 61C, and form a set of candidate interest points with the found candidate interest points.

When the obtaining unit 61 obtains a set of candidate hotels, the first search module 61A searches for candidate hotels within a preset distance to each known location and forms the set of candidate hotels with the found candidate hotels; or, a second search module 61B searches for candidate hotels in a designated area, in an area exclusive of a designated area, on a designated path, or in an area exclusive of a designated path, then forms the set of candidate hotels with the found candidate hotels; or, the finding module 61C first finds a target location point, and then the third search module 61D searches for candidate interest points within a preset distance to the target location point found by the finding module 61C and forms the set of candidate interest points with the found candidate interest points. The set of candidate hotels obtained by any of the preceding three manners acts as a reference for determining a target hotel. Hotels that do no meet requirements of the known locations are filtered out from the set of candidate hotels, and the set of candidate hotels includes the target hotel and other candidate hotels, so that the search range for the target hotel is narrowed down, and the target hotel can be easily found.

Afterward, the finding unit 62 is configured to find the target hotel from the set of candidate hotels, in which location relationships between the target hotel and the three known locations meet the preset rule 1. The target hotel found by the finding unit 22 meets the requirements of each of the known locations, and thus the determination of the interest points according to multiple different locations is also achieved.

### Second Embodiment

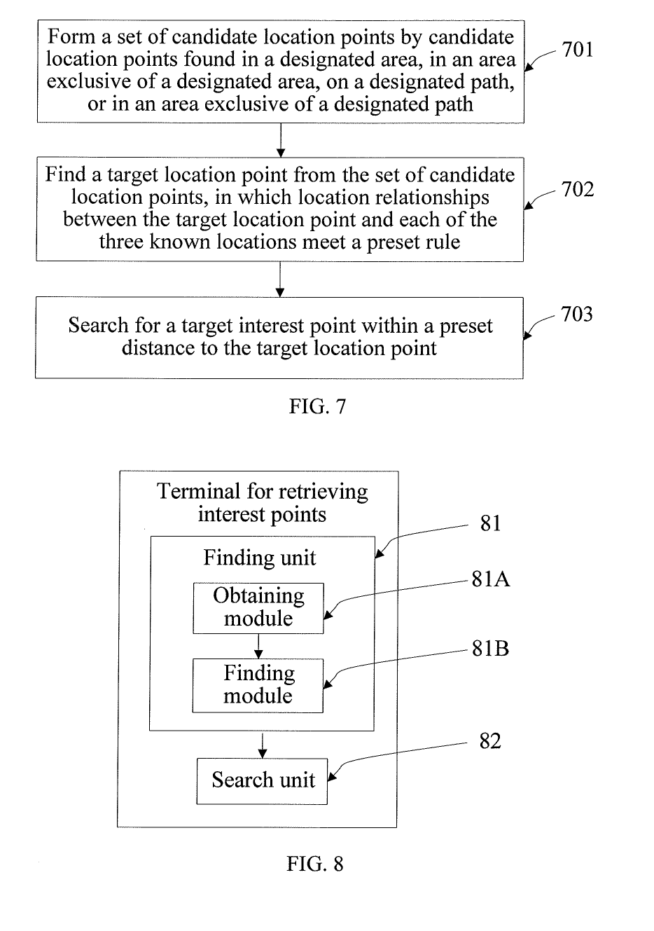

A second method and a second terminal for searching for interest points are provided in the second embodiment. The application scenario of the second embodiment is the same as that in the first embodiment. An implementing process of the second method for searching for interest points is described in detail below. As shown in FIG. 7, the method includes the following blocks:

In block 701, firstly, form a set of candidate location points with candidate location points found in a designated area, in an area exclusive of a designated area, on a designated path, or in an area exclusive of a designated path.

In block 702, find a target location point from the set of candidate location points, in which location relationships between the target location point and each of the three known locations meet a preset rule. The target location point is a reference location for searching for a target interest point. The preset rule includes, but is not limited to, the following.

In Rule A, a difference between any two linear distances is within a preset range, where the two linear distances are among linear distances between the target location point and each of the at least two known locations.

Linear distances between each candidate location point in the set of candidate location points and the three known locations are calculated, and if a difference between the linear distances is within a preset range, the corresponding candidate location point is determined as the target location point. If the preset range is narrow, the linear distances between each of the known locations and the target location point are close or equal.

In Rule B, a difference between any two actual distances is within a preset range, where the two actual distances are among actual distances between the target location point and each of the at least two known locations.

Actual distances between each candidate location point in the set of candidate location points and the three known locations are calculated, and if a difference between the actual distances is within a preset range, the corresponding candidate location point is determined as the target location point. If the preset range is narrow, the actual distances between each of the known locations and the target location point are close or equal.

In Rule C, a difference between any navigation time is within a preset range, where the navigation time is among navigation time between the target location point and each of the at least two known locations.

The time required from each candidate location point in the set of candidate location points to each of the three known locations is calculated, and if a difference between the time is within a preset range, the corresponding candidate location point is determined as the target location point. If the preset range is narrow, the time required from each of the known locations to the target location point by different means of travel is close or equal. The means of travel may be on foot, by car, or by public transport. If the user walks to the hotel, a reference time can be calculated according to the actual distance and the normal speed of a person on foot. The reference time provides a time roughly required by the user. If the user travels by public transport, for example, by subway, a reference time roughly required by the user may be provided according to the schedule of the subway. If the user drives to the hotel, a reference time can be calculated according to the speed of the car and the actual distance.

In Rule D, a sum of linear distances between the target location point and each of at least two known locations is the smallest. A sum of linear distances between each candidate location point in the set of candidate location points and each of the three known locations is calculated, and the candidate location point corresponding to the smallest sum is determined as the target location point.

In Rule E, a sum of actual distances between the target location point and each of at least two known locations is the smallest. A sum of actual distances between each candidate location point in the set of candidate location points and each of the three known locations is calculated, and the candidate location point corresponding to the smallest sum of the actual distances is determined as the target location point.

In Rule F, a sum of navigation time between the target location point and each of at least two known locations is the smallest. A sum of time required from each candidate location point in the set of candidate location points to each of the three known locations is calculated, and the candidate location point corresponding to the smallest sum of the time is determined as the target location point.

The preset rule applied to this embodiment is the same as that in the first embodiment.

In block 703, search for the target hotel within a preset distance to the target location point. Because the target location point meets the requirements of each of the known locations, for example, a requirement of a distance between each of the known locations and the target hotel, or a requirement of time required from each of the known locations to the target hotel, the target hotel obtained by searching within the preset distance to the target location point also meets the requirements of each of the known locations. As the target interest point is determined according to multiple locations, the problem in the prior art that interest points cannot be determined according to multiple locations is solved.

To implement the preceding method, in an embodiment, the present invention also provides a terminal for searching for interest points. As shown in FIG. 8, the terminal includes a finding unit 81 and a search unit 82. The finding unit 81 includes an obtaining module 81A and a finding module 81B.

The obtaining module 81A is configured to search for candidate location points in a designated area, in an area exclusive of a designated area, on a designated path, or in an area exclusive of a designated path, then form a set of candidate location points with the found candidate location points. The finding module 81B is configured to find a target location point from the set of candidate location points obtained by the obtaining module 81A, in which location relationships between the target location point and each of at least two known locations meet a preset rule. The search unit 82 is configured to search for the target interest point within a preset distance to the target location point. The terminal achieves the objective of determining the target interest point according to the at least two known locations.

### Third Embodiment

During the implementation of the embodiment of the present invention, a user may search for a target interest point according to multiple different locations. For example, when a user and his/her friends plan to go out for dinner, the user needs to find a hotel that takes nearly the same time for each person to reach, and thus it does not need to wait too long due to different time of arrival of each person to the hotel. The user may search for a target hotel through a mobile phone with a GPS function. Before searching, the friends of the user may tell the user their locations in different ways. For example, the friends may obtain and send their current location information through GPS mobile phones to the user, and meanwhile inform the user of their means of travel. When receiving the location information from all the friends, the user inputs the location information to a mobile phone or a vehicle GPS applying the method for searching for interest points provided in the embodiment of the present invention. Then, a hotel that meets the requirements of the user is found according to different rules. For example, a hotel that the actual distances between the hotel and the current locations of the user and all his/her friends are equally close is searched for; or, a hotel that the time takes from the hotel to the current locations of the user and all his/her friends is approximately the same according to different means of travel of each person is searched for. Therefore, a target interest point satisfying the actual demand of the user is provided.

The embodiments of the present invention are mainly applied to the field of location services. In the embodiments of the present invention, the target interest point is a hotel as an example for illustration. The target interest point may also be a guesthouse, a shopping mall, or a hospital, depending on different requirements of the user. According to the embodiments of the present invention, the determination of locations of interest points based on multiple locations is achieved, and also the planning of suitable routes leading to multiple locations may also be implemented. For example, a suitable hotel can be determined for a business trip according to several destinations, so that the hotel is equally close to all the destinations. The two methods for searching for interest points provided in the embodiments of the present invention are not only applicable to mobile phones or vehicle GPS, but also applicable to other devices in any form with mobile location services.

Through the preceding description of the implementation, it is clear to persons skilled in the art that the present invention may be accomplished through hardware, or through software plus a necessary universal hardware platform. But in many cases, the software implementation is preferred. Based on this, the preceding technical solutions or the part that makes contributions to the prior art can be substantially embodied in the form of a software product. The computer software product may be stored in a computer readable storage medium such as a floppy disk, a hard disk, or an optical disk, and contain several instructions to instruct computer equipment (for example, a personal computer, a server, or network equipment) to perform the method described in the embodiments of the present invention.

In conclusion, the above are merely exemplary embodiments of the present invention. However, the scope of the present invention is not limited thereto. Changes or replacements readily apparent to persons skilled in the prior art within the technical scope of the present invention should fall within the scope of the present invention. Therefore, the protection scope of the present invention is subject to the appended claims.

1. A method for searching for interest points in a terminal, comprising:
obtaining a set of candidate interest points; and
finding a target interest point from the set of candidate interest points, wherein location relationships between the target interest point and each of at least two known locations meet a preset rule 1.

2. The method for searching for interest points according to claim 1, wherein the obtaining the set of candidate interest points comprises:
searching for candidate interest points within a preset distance to each of the known locations, and forming the set of candidate interest points with the found candidate interest points; or
searching for candidate interest points in a designated area, in an area exclusive of a designated area, on a designated path, or in an area exclusive of a designated path, then forming the set of candidate interest points with the found candidate interest points; or
finding a target location point; and searching for candidate interest points within a preset distance to the target location point and forming the set of candidate interest points with the found candidate interest points, wherein location relationships between the target location point and each of the at least two known locations meet a preset rule 2, and the preset rule 2 is different from the preset rule 1.

3. The method for searching for interest points according to claim 2, wherein the preset rule 1 or the preset rule 2 is that:
a difference between any two linear distances is within a preset range, wherein the two linear distances are among linear distances between the target interest point and each of the at least two known locations; or
a difference between any two actual distances is within a preset range, wherein the two actual distances are among actual distances between the target interest point and each of the at least two known locations; or
a difference between any navigation time is within a preset range, wherein the navigation time is among navigation time between the target interest point and each of the at least two known locations; or
a sum of linear distances between the target interest point and each of the at least two known locations is the smallest; or
a sum of actual distances between the target interest point and each of the at least two known locations is the smallest; or
a sum of navigation time between the target interest point and each of the at least two known locations is the smallest.

4. A terminal for searching for interest points, comprising:
an obtaining unit, configured to obtain a set of candidate interest points; and
a finding unit, configured to find a target interest point from the set of candidate interest points, wherein location relationships between the target interest point and each of at least two known locations meet a preset rule 1.

5. The terminal for searching for interest points according to claim 4, wherein the obtaining unit comprises:
a first search module, configured to search for candidate interest points within a preset distance to each of the known locations, and form the set of candidate interest points with the found candidate interest points.

6. The terminal for searching for interest points according to claim 4, wherein the obtaining unit comprises:
a second search module, configured to search for candidate interest points in a designated area, in an area exclusive of a designated area, on a designated path, or in an area exclusive of a designated path, then form the set of candidate interest points with the found candidate interest points.

7. The terminal for searching for interest points according to claim 4, wherein the obtaining unit comprises:
a finding module, configured to find a target location point, wherein location relationships between the target location point and each of the at least two known locations meet a preset rule 2, and the preset rule 2 is different from the preset rule 1; and
a third search module, configured to search for candidate interest points within a preset distance to the target location point found by the finding module, and form the set of candidate interest points with the found candidate interest points.

8. A method for searching for interest points in a terminal, comprising:
finding a target location point, wherein location relationships between the target location point and each of at least two known locations meet a preset rule; and
searching for a target interest point within a preset distance to the target location point.

9. The method for searching for interest points according to claim 8, wherein the finding the target location point comprises:
searching for candidate location points in a designated area, in an area exclusive of a designated area, on a designated path, or in an area exclusive of a designated path, then forming a set of candidate location points with the found candidate location points; and
finding a target location point from the set of candidate location points, wherein location relationships between the target location point and each of the at least two known locations meet a preset rule.

10. The method for searching for interest points according to claim 8, wherein the preset rule is that:
a difference between any two linear distances is within a preset range, wherein the two linear distances are among linear distances between the target location point and each of the at least two known locations; or
a difference between any two actual distances is within a preset range, wherein the two actual distances are among actual distances between the target location point and each of the at least two known locations; or
a difference between any navigation time is within a preset range, wherein the navigation time is among navigation time between the target location point and each of the at least two known locations; or
a sum of linear distances between the target location point and each of the at least two known locations is the smallest; or
a sum of actual distances between the target location point and each of the at least two known locations is the smallest; or
a sum of navigation time between the target location point and each of the at least two known locations is the smallest.

11. The method for searching for interest points according to claim 9, wherein the preset rule is that:
a difference between any two linear distances is within a preset range, wherein the two linear distances are among linear distances between the target location point and each of the at least two known locations; or
a difference between any two actual distances is within a preset range, wherein the two actual distances are among actual distances between the target location point and each of the at least two known locations; or
a difference between any navigation time is within a preset range, wherein the navigation time is among navigation time between the target location point and each of the at least two known locations; or
a sum of linear distances between the target location point and each of the at least two known locations is the smallest; or
a sum of actual distances between the target location point and each of the at least two known locations is the smallest; or
a sum of navigation time between the target location point and each of the at least two known locations is the smallest.

12. A terminal for searching for interest points, comprising:
a finding unit, configured to find a target location point, wherein location relationships between the target location point and each of at least two known locations meet a preset rule; and
a search unit, configured to search for a target interest point within a preset distance to the target location point.

13. The terminal for searching for interest points according to claim 12, wherein the finding unit comprises:
an obtaining module, configured to search for candidate location points in a designated area, in an area exclusive of a designated area, on a designated path, or in an area exclusive of a designated path, then form a set of candidate location points with the found candidate location points; and
a finding module, configured to find a target location point from the set of candidate location points, wherein location relationships between the target location point and each of the at least two known locations meet a preset rule.
